(19) United States
(12) Patent Application Publication
(10) Pub. No.: US 2014/0193574 A1
(43) Pub. Date: Jul. 10, 2014

(54) GRAPHENE MANUFACTURING SYSTEM AND THE METHOD THEREOF

(71) Applicant: Chao-Hui Yeh, Hsinchu (TW)

(72) Inventor: Chao-Hui Yeh, Hsinchu (TW)

(21) Appl. No.: 13/934,449

(22) Filed: Jul. 3, 2013

(30) Foreign Application Priority Data
Jan. 10, 2013 (TW) 102100842

(51) Int. Cl. C01B 31/04

(52) U.S. Cl. CPC C01B 31/0453
USPC 427/122; 118/704

(57) ABSTRACT

The present invention discloses a graphene manufacturing system and the method thereof. In the prior arts, constant gas flows are used for the growth of graphene layers on work pieces. In contrast, the present invention makes use of multiple pulses of gas flows to grow graphene layers with low sheet resistivity.

### PRIORITY CLAIM

This application claims the benefit of the filing date of Taiwan Patent Application No. 102100842, filed Jan. 10, 2013, entitled “A GRAPHENE MANUFACTURING SYSTEM AND THE METHOD THEREOF,” and the contents of which is hereby incorporated by reference in its entirety.

### FIELD OF THE INVENTION

The present invention relates to a graphene manufacturing system and the method thereof, more particularly, to a system and a method for improving the quality of graphene by changing the import rate of different gases during chemical vapor deposition.

### BACKGROUND OF THE INVENTION

Graphene is a material made of pure carbon with atoms arranged in a regular hexagonal pattern similar to graphite, but in a one-atom thick sheet. It is an allotrope of carbon with its structure being a single planar sheet of sp2-bonded carbon atoms that are densely packed in a honeycomb crystal lattice. Presently, graphene is the thinnest and most solid nanomaterial, while being almost transparent with good thermal conductivity. The electrical resistivity of graphene is lower than copper and silver. Due to the above advantages, graphene is expected to be used for developing new electronic components or transistors. Since graphene is almost transparent and good conductor, it is an appropriate substance to manufacture optoelectronic devices such as touch screens, light boards and even solar cells.

To synthesize graphene, X. Li et al. disclosed a method by using copper foils as a base, and providing the base with gasiform carbon feedstock at 1,000° C. to form graphene layers on a surface of the base, where the graphene layers can then be transferred to a work piece. The transition metal element catalyzes the decomposition of carbon feedstock to generate a plurality of carbon atoms, and the plurality of carbon atoms form the graphene layers directly on the surfaces of the metal due to the low carbon solubility of copper. Therefore, the quality of the graphene layers depends on crystallinity and grain size of copper. The resistivity or electron mobility is lower if there are more crystal defects in the graphene layers and if the grain size is small. On the contrary, the resistivity or electron mobility is higher if there are less crystal defects in the graphene layers and the grain size is big. The sheet resistivity of graphene layers before doping is about 1000Ω/□, (Ω/sq.), and the electron mobility is about 500-3000 cm2/Vs. Thus, the sheet resistivity of graphene layers is too high to be applied in a transparent conductive field. It is also difficult to be applied in flexible substrates as a transparent conductive product like a touch panel because there is no advantage in competing with current ITO process.

In view of the above, there is no current process that can generate high quality graphene layers. Thus, developing a process or system for generating high quality graphene layers is an underlying problem.

### SUMMARY OF THE INVENTION

One objective of the present invention is to provide a graphene manufacturing system for growing graphene layers on the surface of a work piece, and the graphene manufacturing system comprises a furnace body, a first gas source, a first valve, a second gas source, a second valve, a third gas source, a third valve and a control device. The furnace body has a working chamber for holding the work piece. The first gas source is connected with the working chamber for providing the working chamber with a first gas. The first valve is configured between the working chamber and the first gas source. The second gas source is connected with the working chamber for providing the working chamber with a second gas. The second valve is configured between the working chamber and the second gas source. Similarly, the third gas source is connected with the working chamber for providing the working chamber with a third gas and the third valve is configured between the working chamber and the third gas source. The control device is coupled with the first valve, second valve and the third valve. The control device stores process data, i.e. the data corresponds to a first process, a second process and a third process. Each process seriatim comprises a first command, a second command, a third command and a fourth command. The first command is for increasing the flow rate of the corresponding valve, the second command is for decreasing the flow rate of the corresponding valve, the third command is for increasing the flow rate of the corresponding valve, and the fourth command is for decreasing the flow rate of the corresponding valve. The working time of each command is based on the size of the graphene layers and the working temperature.

In actual application, the control device uses the process data to control the first valve, the second valve and the third valve respectively by the first process, the second process and the third process, and also to control the flow rate of said valves. After the first gas is imported into the working chamber, the high temperature catalyzes the decomposition of the first gas to generate the graphene layers on the surfaces of the work piece.

Alternatively, the present invention also discloses a graphene manufacturing method corresponding to the above graphene manufacturing system. The graphene manufacturing method comprises of the following steps: setting the work piece in the working chamber; raising the temperature to the reactive temperature; importing the first gas into the working chamber by a first process; importing the second gas into the working chamber by a second process; and importing the third gas into the working chamber by a third process. Each process comprises a plurality of reacting stages, with each reacting stage comprising a first segment, a second segment, a third segment and a fourth segment respectively corresponding to the first command, the second command, the third command and the fourth command of the graphene manufacturing system. By the different flow control to the three imported gases, the high temperature catalyzes the decomposition of the first gas to generate a plurality of carbon atoms. Parts of the plurality of carbon atoms form the graphene layers due to the change of flow rate of different gases and parts of the plurality of carbon atoms disappear due to the reaction with hydrogen. With the above mentioned method, the present invention makes graphene layers with low sheet resistivity and big grain sizes.

In addition, the work piece can comprise a metal foil, the first gas can be a carbonaceous gas, the second gas can be a hydrogen-containing gas, the third gas can be an argon-containing gas or the combination of other inert gases. In actual application, the volume flow rate of the first gas during the first segment and the third segment are between 2 sccm and 640 sccm, the volume flow rate of the second gas during the first segment, the second segment, the third segment and the fourth segment are between 8 sccm and 860 sccm, the volume flow rate of the third gas during the first segment, the second segment, the third segment and the fourth segment are between 300 sccm and 4,200 sccm.

According to the above mentioned scenario, the present invention discloses a system and a method for manufacturing graphene. In the prior arts, constant gas flows are used for the growth of graphene layers on work pieces. In contrast, the present invention makes use of multiple pulses of gas flow to improve the quality of the graphene layers and to grow graphene layers with low sheet resistivity.

Many other advantages and features of the present invention will be further understood by the following detailed description and the appended drawings.

### BRIEF DESCRIPTION OF THE DRAWINGS

FIG. 1: Schematic diagram illustrating the graphene manufacturing system according to an embodiment of the invention.

FIG. 2: Temperature vs. time and pressure vs. time profiles according to an embodiment of the invention.

FIG. 3A to 3D: Schematic diagrams illustrating the performance of the graphene layers of the invention.

FIG. 4A to 4C: Pressure vs. time diagrams illustrating different situations of pressure change of imported gases during graphene growth according to other embodiments of the invention.

To facilitate understanding, identical reference numerals have been used, where it is possible to designate identical elements that are common to the figures.

### DETAILED DESCRIPTION

The present invention discloses a graphene manufacturing system and process for growing graphene layers. It utilizes a system similar to the existing system to generate high quality graphene layers. In short, the innovation of the present invention is the use of a new gas supply process to improve the quality of graphene layers.

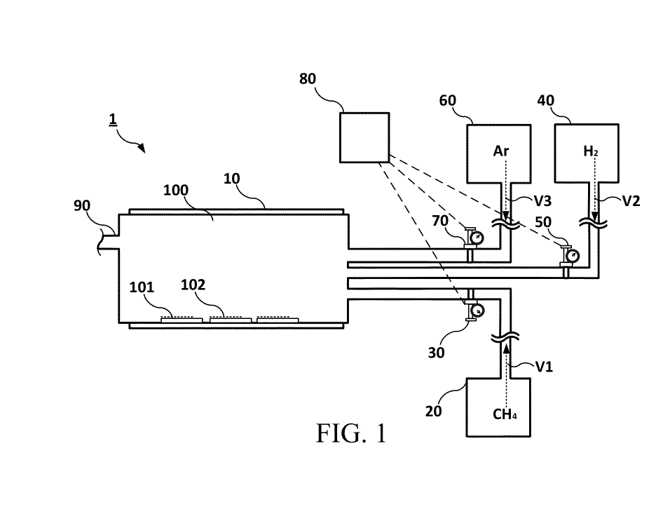

Please refer to FIG. 1. FIG. 1 shows a schematic diagram illustrating the graphene manufacturing system according to an embodiment of the invention. In this embodiment, the system 1 comprises a furnace body 10, a first gas source 20, a second gas source 40, a third gas source 60, a first valve 30, a second valve 50, a third valve 70 and a control device 80.

It is clear that the present invention is similar to the prior art which uses a thermal decomposition of gaseous chemical synthesis method. This invention can be applied into the system of the prior art directly instead of requiring new equipment. Alternatively, the key point of this invention is the modified gas supply process of the system. Thus, the following description is all about features of the gas supply process and other details of the system are omitted.

In short, the first gas source 20 is used for providing a first gas V1, the second gas source 40 is used for providing a second gas V2, the third gas source 60 is used for providing a third gas V3. The first valve 30, the second valve 50 and the third valve 70 are configured in the connecting parts between a working chamber 100 and the first gas source 20, the second gas source 40 and the third gas source 60 respectively. These valves are used for controlling the gas flow rate from the gas sources to the working chamber 100.

In actual application, a work piece 101 is configured in the working chamber 100 of the furnace body 10. A heating device of the furnace body 10 heats the working chamber 100 and maintains the interior of the working chamber 100 at a high temperature. Then, the control device 80 controls the first valve 30, second valve 50 and third valve 70 by the first process, second process and third process respectively, so as to import the first gas V1, second gas V2 and third gas V3. In this embodiment, the first gas V1 is a carbonaceous gas. After the first gas V1 enters the working chamber 100, the high temperature catalyzes the decomposition of the first gas V1 to generate a plurality of carbon atoms that form the graphene layers 102 on the surfaces of the work piece 101. A key difference to the prior art is that the present invention uses constant gas flows and makes use of multiple pulses of gas flows to improve the quality of graphene layers.

The following are descriptions of each component. First, in the embodiment of FIG. 1, the furnace body 10 is an apparatus for chemical vapour deposition processes, and it can be made up of quartz, ceramics, stainless steel or other refractory materials. Further, there is a heating device in the furnace body 10 that can heat the working chamber 100 to a high temperature more than 1,000 degrees centigrade.

Alternatively, the furnace body 10 is connected to a plurality of switches to control the above first valve 30, second valve 50 and third valve 70. Furthermore, the first valve 30, second valve 50 and third valve 70 are connected to the first gas source 20, second gas source 40 and third gas source 60 respectively. Therefore, the control device 80 controls the import flow rate of the first gas V1, second gas V2 and third gas V3 to the working chamber 100 by controlling the opening and closing of the first valve 30, second valve 50 and third valve 70. The furnace body 10 further comprises an exit gate 90 for discharging fluid after process.

The above control device 80 is coupled with the first valve 30, second valve 50 and third valve 70 and stores a process data to control the above three valves. The control device 80 of the present invention is a computer having a control process data, but not limited to this. In the simplest type, the control device 80 can even be a chip. In this embodiment, the first valve 30, second valve 50 and third valve 70 are configured in the same side of the furnace body 10, but is not limited to this. The arrangement of the valves depends on the demand from users. The above control device 80 stores a process data, the process data corresponds to a first process, a second process and a third process. In actual application, the control device 80 utilizes the process data to control the first valve 30, second valve 50 and third valve 70 by the first process, second process and third process respectively.

Alternatively, the work piece 101 configured in the working chamber 100 is a copper foil or a substrate with transition metal catalyst coating. In this embodiment, for optimization, the copper foil is processed by a cleaning process that utilizes a cleaning liquid having acetone, isopropanol, acetic acid and deionized water. To further improve the quality of graphene layers, the surfaces of the work piece can be processed by a plasma treatment before going through the above process, where the plasma treatment is performed by plasma having oxygen or argon. Moreover, a seed can be configured on the surface of the work piece to improve the quality of graphene layers. The seed can be a glass graphite fragment or a carbonaceous depositition, where the location and size of the carbonaceous deposition is preciselly controlled by lithography. The work piece 101 is not limited to the above, it can be predetermined depending on the demand from users. The work piece 101 can be, but is not limited to, a copper foil or a substrate made of silica, quartz, sapphire, glass, sodium chloride, silicon nitride, alumina or combinations thereof. Furthermore, the work piece 101 of the present invention can also be made of an electrically insulating material or other amorphous materials. Importantly, in this embodiment, the work piece 101 is a copper foil used as a catalyst. The work piece 101 can also be the above insulating materials with metal foil set on top or adjacent to the work piece 101, so as to obtain the copper catalyst particles by means such as gasification. In addition, the above metal catalyst particle is not limited just to copper, but also includes iron, cobalt, iridium, nickel, zinc or alloy thereof. Further, in some cases, the metal catalyst particles can be omitted by a pyrolysis process instead. In actual application, a plurality of work pieces 101 are set in the working chamber 100, where the plurality of work pieces 101 are then arranged in a matrix or separated along the width or depth direction of the furnace body 10. The arrangement of the plurality of work pieces 101 is not limited to the invention; it can be predetermined depending on the demand from users.

Alternatively, the present invention comprises of the first gas source 20, second gas source 40 and third gas source 60. In this embodiment, the first gas source 20 comprises a methane-containing gas, the second gas source 40 comprises a hydrogen-containing gas, and the third gas source 60 comprises an argon-containing gas. However, the first gas V1 is not limited to methane but can also be a carbonaceous gas to provide carbon particles required for the process. In actual application, the first gas V1 can be methane, acetylene, ethylene, benzene or any other materials having carbon molecules. Further, the carbon feedstock 31 (but it is not mentioned in FIG. 1) can be a mixture of a gaseous carbon molecules with an inert gas. In addition, the second gas V2 is not limited to pure hydrogen but can also be a hydrogen-containing gas mixture. The third gas V3 is not limited to argon but can also be the combination of other inert gases.

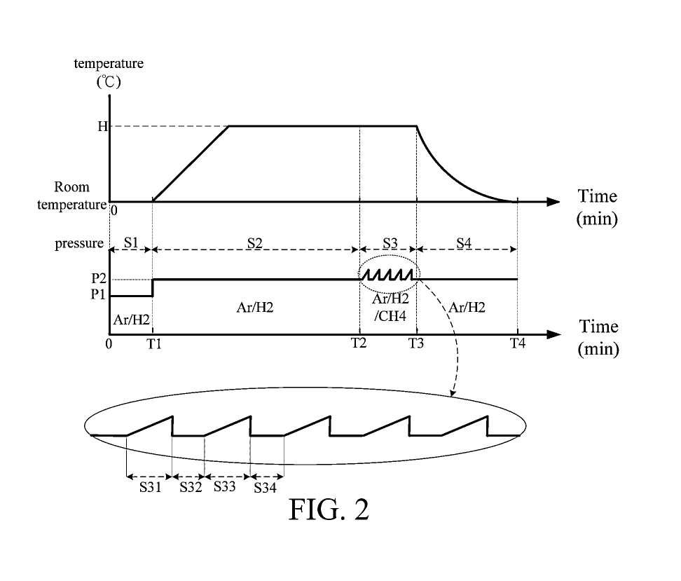

After the description of the apparatus mentioned above, the following is about the method of the present invention. Please refer to FIG. 1 and FIG. 2. FIG. 2 shows temperature vs. time and pressure vs. time profiles according to an embodiment of the invention. In actual application, the process of the present invention generally includes few steps. First, preparing and assembling the above furnace body 10, the first gas source 20, second gas source 40, third gas source 60, first valve 30, second valve 50, third valve 70 and the control device 80 (the assembly methods of each component are shown in FIG. 1). Then, importing the first gas into the working chamber by the first process. The first process seriatim contains a preparing stage S1, a pre-processing stage S2, a reaction stage S3 and an end stage S4.

During the preparing stage S1, the work piece 101 is set in the working chamber 100, and the second valve 50 and third valve 70 are turned on to import the second gas V2 and third gas V3 into the working chamber 100 to form a background gas. The reaction time for the preparing stage S1 is T1. In this embodiment, the reaction time T1 is about few minutes, where the second gas V2 is hydrogen and the third gas V3 is argon. At the same time, in the preparing stage S1, the first valve 30 is not open, and the first gas V1 is not imported into the working chamber 100 yet. The pressure in the working chamber during this stage is defined as a pressure P1 and its value is about 740 pressure units.

The next step is the pre-processing stage S2. In this stage, the imported gases like the second gas V2 and third gas V3 are increased, and the working chamber 100 is heated at a rate of about 20 degrees per minute to reach a reaction temperature H and continues for some time. In the pre-processing stage S2, the first valve 30 is still not open, and the first gas V1 has yet to be imported into the working chamber 100. The pressure in the working chamber during this stage is defined as a pressure P2 and its value is about 760 pressure units.

In this embodiment, the above reaction temperature H is between 900-1050 degrees Celsius, with the preferred temperature being 1000 degrees Celsius. The growth time is between 10-30 minutes, depending on the reaction temperature. By this heat treatment stage, the oxide on the copper foil surface is being removed and the internal stress is released by recrystallization to make the copper foil surface more smooth. In this embodiment, the end time of the pre-processing stage S2 is defined as time T2, and the time T2 is about 5-180 minutes.

Subsequently, in the reaction stage S3, the control device 80 opens the first valve 30 to import the first gas V1 into the working chamber 100. In this embodiment, the first gas V1 is a carbonaceous gas. In the prior arts, the gas flows used for the growth of graphene layers are constant. In contrast, the control device 80 of the present invention controls the import flow rate of the first gas V1 by controlling the opening and closing of the first valve 30. In this embodiment, the end time of the reaction stage S3 is defined as time T3, and it is about 15-200 minutes.

Further, please refer to FIG. 2. The above reaction stage S3 can seriatim comprise, but is not limited to, a first segment S31, a second segment S32, a third segment S33 and a fourth segment S34. The average import flow rate of the first gas V1 during the first segment S31 is higher than during the pre-processing stage S2. The average import flow rate of the first gas V1 during the second segment S32 is lower than during the first segment S31, the average import flow rate of the first gas V1 during the third segment S33 is higher than during the second segment S32, and the average import flow rate of the first gas V1 during the fourth segment S34 is lower than during the third segment S33. That is to say, the gas supply during the reaction stage S3 has changed continuously (first increase and then decrease in one cycle), which is different to that of constant gas supply process in the prior art.

To be more specific, in this embodiment, at the beginning of the first segment S31 and the third segment S33, the import flow rate of the first gas V1 into the working chamber 100 is zero or nearly zero. At the beginning of the first segment S31 and the third segment S33, the control device 80 outputs a first command and a third command to the first valve 30 so as to open the valve and import the first gas V1 into the working chamber 100 from the first gas source 20 at a rate of 2-640 sccm for few seconds. Furthermore, at the beginning of the second segment S32 and the fourth segment S34, the control device 80 outputs a second command and a fourth command to the first valve 30 to close the valve and stop importing the first gas V1 into the working chamber 100 for few seconds. By repeating the above process, the entire process takes about 10-30 minutes. In addition, it should be noted that the above addition and subtraction of the flow rate is controlled within one single process and the work piece has not been replaced or moved during the process. More specifically, during the first command and the fourth command, the work piece is at a specified location in the working chamber.

By using multiple pulses of gas flows to grow graphene layers, the carbon particles from the first gas V1 can be fully reacted and deposited to improve the quality of the graphene layers 102.

More importantly, the beginning and the end of each segment can be controlled by the duration of time, the flow rate, or the pressure in the working chamber 100 where the present invention is not limited to it.

With the end of the reaction stage S3, the following is the end stage S4. The end stage S4 is similar to the pre-processing stage S2, with the difference being that the working chamber 100 stops being heated to make the temperature of the working chamber 100 drop rapidly. In this embodiment, the end time of the end stage S4 is defined as time T4, and the time T4 is about 75-240 minutes. With the effect of the above pre-processing stage S2, the reaction stage S3 and the end stage S4, the quality of the graphene layers can be greatly improved.

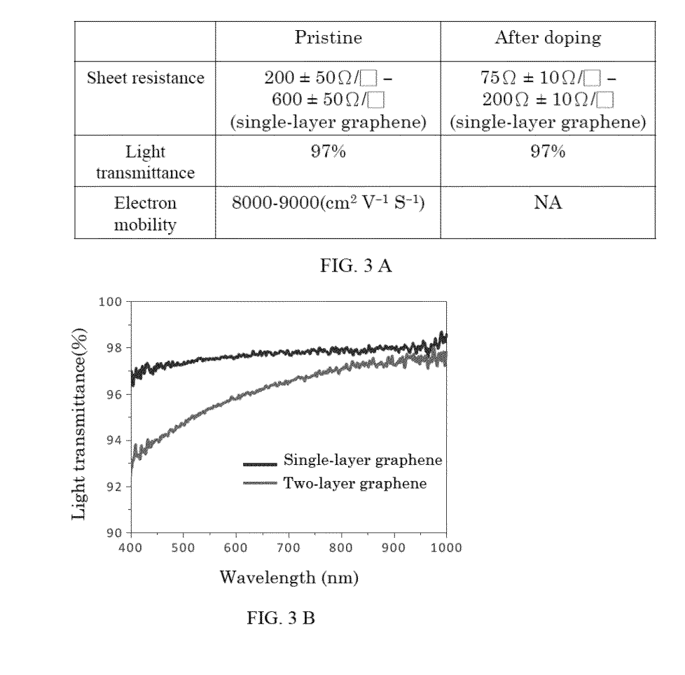

It should be emphasized that the parameters such as the time, temperature and pressure in the above description are just one case of the feasible parameters. In actual application, the above parameters can be adjusted or changed with different materials, processes or demands of the quality of the work piece. Please refer to FIG. 3A to FIG. 3D. FIG. 3A to FIG. 3D are schematic diagrams illustrating the performance of the graphene layers of the present invention. The resistivity of each graphene sheet before doping is between 200 to 600Ω/□, (Ω/sq.), but the resistivity of each graphene sheet after doping (such as auric chloride) is between 75 to 200Ω/□., (Ω/sq.), FIG. 3B shows that the optical transmittance of each graphene sheet is up to 97%. The graphene layers of the present invention have few lattice defects, observed from the Raman spectrum of FIG. 3C. The high quality of the graphene layers of the present invention is also reflected from the high on/off ratio of a graphene based transistor. As shown in FIG. 3D, the on/off ratio of a graphene transistor of the present invention is up to 13. In addition, the graphene layers of the present invention consists of 1 to 10 graphene sheets with the coverage rate thereof being up to 99.9% or more. In other words, in view of a transmission electron microscope, the number of holes bigger than 100 nm2 is less than 20 per 10 micron square.

In summary, the main technical means of the present invention is the use of multiple pulses of gas flows to improve the quality of the graphene layers 102. Whether the valves need to be closed completely or not is not limited in the invention. To be more specific, any other methods for improving the quality of the graphene layers by changing the gas flow rate should be included in the present invention.

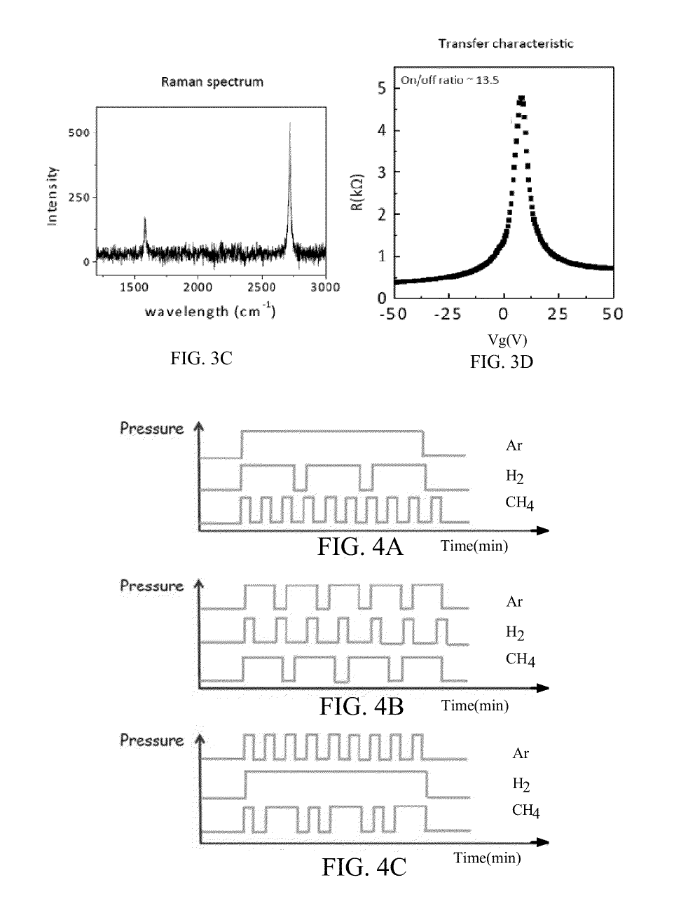

In the previous embodiment, only the flow rate of the first gas V1 is controlled and changed. However, the present invention can further control the flow rate and entry timing of the first gas V1, second gas V2 and third gas V3 to obtain better results. Please refer to FIG. 4A to FIG. 4C. FIG. 4A to 4C are the representative pressure vs. time profiles illustrating different situations of pressure change of imported gases during the growth of graphene layers according to other embodiments of the invention. The gas flow rate of the second gas V2 and the third gas V3 during every segment are just like the first gas V1, so the detailed description is omitted here. More specifically, the second gas V2 and the third gas V3 are like the first gas V1 and have a second process and a third process. Each process seriatim contains a preparing stage, a pre-processing stage, a reaction stage and an end stage, and the above reaction stages seriatim comprise a first segment, a second segment, a third segment and a fourth segment. It should be noted that the second gas V2 and the third gas V3 do not necessarily have to exist simultaneously in actual application. In addition, the second gas V2 as well as the third gas V3 can contain hydrogen, argon, and other gases or can be a gas mixture before being imported into the working chamber.

According to the above embodiment, the present invention discloses a system and method for manufacturing graphene. In the prior arts, constant gas flows are used for the growth of graphene layers on work pieces. In contrast, the present invention makes use of multiple pulses of gas flows to improve the quality of graphene layers and to grow graphene layers with low sheet resistivity.

With the examples and explanations mentioned above, the features and spirits of the invention are hopefully well described. Importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

1. A graphene manufacturing system for growing graphene layers on the surface of a work piece comprising of following items:
a furnace body having a working chamber for holding the work piece;
a first gas source, connected with the working chamber for providing the working chamber with a first gas;
a first valve, configured between the working chamber and the first gas source;
a second gas source, connected with the working chamber for providing the working chamber with a second gas;
a second valve, configured between the working chamber and the second gas source;
a third gas source, connected with the working chamber for providing the working chamber with a third gas;
a third valve, configured between the working chamber and the third gas source; and
a control device, coupled with the first valve, second valve and third valve for storing a process data. The process data is corresponding to a first process, second process and third process, each process seriatim comprising a first command, second command, third command and fourth command. The first command for increasing the flow rate of the corresponding valve, the second command for decreasing the flow rate of the corresponding valve, the third command for increasing the flow rate of the corresponding valve, the fourth command for decreasing the flow rate of the corresponding valve;
wherein, the control device controls the first valve, second valve and third valve respectively by the first process, second process and third process. The control device controls the flow rate of the valves to import the first gas into the working chamber, the high temperature catalyzes the decomposition of the first gas to generate a plurality of carbon atoms, and the plurality of carbon atoms form the graphene layers on the insulated surfaces of the work piece.

2. The graphene manufacturing system of claim 1, wherein the work piece comprises a copper foil or a substrate with copper coating.

3. The graphene manufacturing system of claim 1, wherein the work piece comprises an insulated substrate, the insulated substrate comprises silica, alumina, boron nitride, hafnia or zirconia.

4. The graphene manufacturing system of claim 1, wherein the first gas is a carbonaceous gas, the carbonaceous gas comprises methane, acetylene, ethylene, benzene, methanol or ethanol, the second gas comprises hydrogen, the third gas comprises argon.

5. The graphene manufacturing system of claim 1, wherein the graphene layers consist of 1 to 10 graphene sheets, and the resistivity of each graphene sheet before doping is between 200 to 600Ω/□, (Ω/sq.), the resistivity of each graphene sheet after doping is between 75 to 200Ω/□, (Ω/sq.).

6. A method for manufacturing graphene, applied to grow graphene layers on an insulated surface of a work piece, comprising the following steps of:
preparing a furnace body having a working chamber;
preparing the work piece;
preparing a first gas, second gas and third gas;
setting the work piece in the working chamber;
importing the first gas into the working chamber by a first process;
importing the second gas into the working chamber by a second process; and
importing the third gas into the working chamber by a third process;
wherein, the first process comprises a preprocess stage and a following reacting stage, the reacting stage comprises a first segment, second segment, third segment and fourth segment. The import flow rate of the first gas during the first segment is higher than during the preprocess stage, the average import flow rate of the first gas during the second segment is lower than during the first segment, the average import flow rate of the first gas during the third segment is higher than during the second segment, the average import flow rate of the first gas during the fourth segment is lower than during the third segment. The high temperature catalyzes the decomposition of the first gas to generate a plurality of carbon atoms, and the plurality of carbon atoms form the graphene layers on the insulated surfaces of the work piece.

7. The method for manufacturing graphene of claim 6, wherein the work piece comprises a copper foil or a substrate with copper coating.

8. The method for manufacturing graphene of claim 6, wherein the first gas is a carbonaceous gas, the carbonaceous gas comprises methane, acetylene, ethylene, benzene, methanol or ethanol, the second gas comprises hydrogen, the third gas comprises argon.

9. The method for manufacturing graphene of claim 6, wherein the volume flow rate of the first gas during the first segment and the third segment are between 2 sccm and 640 sccm. The volume flow rate of the second gas during the first segment and the third segment are between 8 sccm and 860 sccm. The volume flow rate of the third gas during the first segment and the third segment are between 300 sccm and 4,200 sccm.

10. The method for manufacturing graphene of claim 6, wherein the surfaces of the work piece can be processed by a plasma treatment.

11. The method for manufacturing graphene of claim 6, wherein at least one seed can be configured on the surface of the work piece.
